(19) United States
(12) Patent Application Publication
(10) Pub. No.: US 2023/0230386 A1
(43) Pub. Date: Jul. 20, 2023

(54) AUTOMOBILE VIDEO CAPTURE AND PROCESSING

(71) Applicant: BuggyVision LLC, Bluffdale, UT (US)

(72) Inventors: W. Eric SMITH, Alpine, UT (US); Brian R. GEPHART, Bluffdale, UT (US); Paula D. GEPHART, Bluffdale, UT (US)

(21) Appl. No.: 18/156,923

(22) Filed: Jan. 19, 2023

Related U.S. Application Data
(60) Provisional application No. 63/301,030, filed on Jan. 19, 2022.

(51) Int. Cl. G06V 20/56; G06V 20/40; G01P 15/18

(52) U.S. Cl. CPC G06V 20/56; G06V 20/44; G06V 20/49; G01P 15/18

(57) ABSTRACT

A method may include capturing, by a camera, video data that relates to operation of the automobile. The method may include storing the video data using a first data storage device that includes a first storage capacity in which older video data included in the first data storage device is overwritten by newer video data upon exceeding the first storage capacity. The method may include determining whether an event has occurred at a given time point, and responsive to determining that the event has occurred, identifying a video segment included in the first data storage device that corresponds to the event. The method may include storing the video segment using a second data storage device. The method may include identifying a reviewing entity to which the video segment may be sent based on video content of the video segment and sending the video segment to the identified reviewing entity.

### CROSS-REFERENCE TO RELATED APPLICATION

This application claims the benefit of U.S. Patent Application Ser. No. 63/301,030, filed on Jan. 19, 2022, the disclosure of which is incorporated herein by reference in its entirety.

### FIELD OF THE INVENTION

The present disclosure generally relates to a system and a method of automobile video capture and processing.

### BACKGROUND

An automobile may include cameras that capture images and/or videos related to driving the automobile. Capturing visual information related to the driving of the automobile may clarify how an automobile collision occurs and may protect a driver of the automobile from liability. The cameras implemented with the automobile often include dashcams mounted inside of the automobile and/or camera sensors mounted on the exterior of the automobile.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include capturing, by a camera associated with an automobile, video data that relates to operation of the automobile during the operation of the automobile. The method may include storing the video data using a first data storage device that includes a first storage capacity, wherein storing the video data using the first data storage device includes overwriting video data stored in the first data storage device with newer video data upon the video data stored in the first data storage exceeding the first storage capacity. The method may include determining whether an event has occurred at a given time point included in the video data, and responsive to determining that the event has occurred at the given time point, identifying a video segment included in the first data storage device that corresponds to the event. The method may include storing the video segment corresponding to the event using a second data storage device that includes a second storage capacity larger than the first storage capacity. The method may include identifying a reviewing entity to which the video segment is to be sent, the identifying being based on video content included in the video segment and sending, from the second data storage device, the video segment to the identified reviewing entity.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is a diagram of an example embodiment of a video-capture system according to one or more embodiments of the present disclosure.

FIG. 2 depicts an example process of generating video segments and sending the video segments to one or more reviewing entities according to the video-capture system described in one or more embodiments of the present disclosure.

FIG. 3 is a flow chart of an example method of capturing and processing video data according to one or more embodiments of the present disclosure.

FIG. 4 illustrates an example computing system configured to capture and process video data according to one or more embodiments of the present disclosure.

### DETAILED DESCRIPTION

With the development of low-cost video cameras (e.g., mobile phones, security cameras, etc.), high-bandwidth network connections and inexpensive data storage, it has become more common to find video capture in many public and private spaces. Cameras are commonly mounted in automobiles (e.g., dashcams), and captured video has been used for insurance and liability issues and to monitor commercial drivers. Although automobiles are often equipped with video capture, the automobiles may not be equipped to upload or otherwise use the captured video except in particular circumstances, such as when an accident occurs.

Furthermore, identification of relevant video segments included in the video data may be rudimentary. Existing video-capture systems for automobiles may include a video camera with a local data storage for video data captured by the video camera. Such video-capture systems often rely on a circular buffer system in which the oldest video segments are overwritten by current video data, and a user may be needed to review video footage and manually identify events included in the video data that may be of interest to the user or a third-party reviewing entity. Additionally or alternatively, the circular buffer system may overwrite important video segments that were missed by the user.

The present disclosure relates to, among other things, a system and a method of capturing and processing video data relating to and/or during operation of an automobile. In some embodiments, the availability of video capture may be used to establish social networks (or a group on an existing social network) for reporting interesting events that happen in or viewed from automobiles. To enable captured video to be used in novel and interesting ways, a dash- or window-mounted video camera may be equipped with accelerometers and/or an artificial intelligence system to detect interesting events when driving. When the artificial intelligence system detects that something interesting has happened, video from several seconds before the interesting event and for several seconds after may be tagged based on what was detected. In some embodiments, interesting events may include, for example, reckless drivers, accidents, storms, rainbows, beautiful scenery, wildlife sightings, roadside hazards, some combination thereof, or any other occurrences in the proximity of and/or in view of the automobile.

The camera may communicate with an application on a user's smartphone via Bluetooth or another technology to let the user know that there is something to review and/or to potentially post on a social network that is configured or implemented as described herein. The video-capture system may include an in-car mode in the application that permits the user (e.g., driver or passenger) to touch one button to immediately post video data during operation of the automobile. In some embodiments, the video-capture system may include a way to post the video data and/or one or more video segments later from the camera. Additionally or alternatively, the video-capture system may permit the user to touch a single button on the app to tag a particular video segment and save the particular video segment for later review even when the artificial intelligence system has not detected an interesting event to be tagged.

The video-capture system may facilitate processing and analysis of video segments by a reviewing entity. For example, the reviewing entity may be a law enforcement body that subscribes to local social media postings including emergency tags to enable faster police dispatch responses and/or gather video evidence for prosecution where applicable. As an additional or alternative example, the reviewing entity may be an automobile insurance company that receives one or more video segments to facilitate monitoring users' driving data through the social network and adjusting insurance rates of the user based on the user's driving data. Video segments may be posted to a user's social media account, blogging website, cloud storage, or any other location for personal and/or public purposes.

The video-capture system according to one or more embodiments of the present disclosure may facilitate and/or improve user operation of an automobile by making recording and managing video data during operation of the automobile easier for the user. Because a human user may not safely divert attention from driving to manage video data captured by existing camera systems, the video-capture system of the present disclosure may simultaneously improve the safety of automobile operation and improve the accuracy and effectiveness of capturing video data during operation of the automobile.

Embodiments of the present disclosure are explained with reference to the accompanying figures.

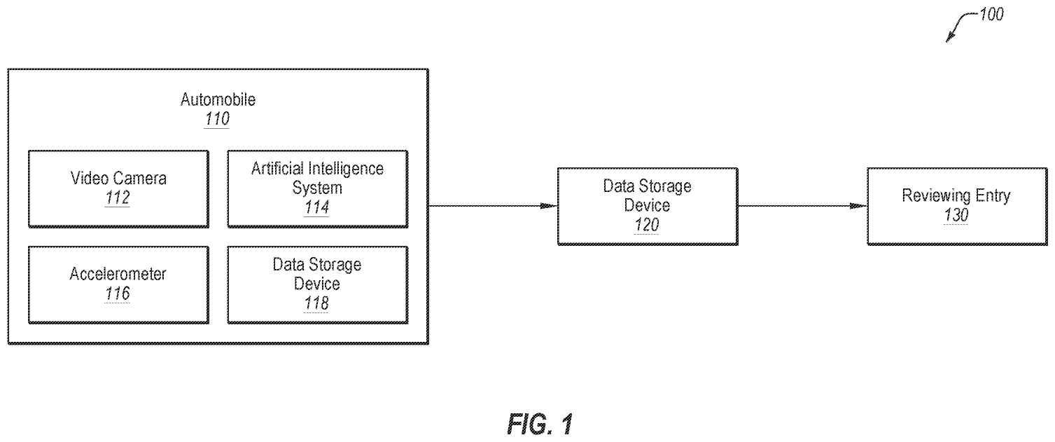

FIG. 1 is a diagram of an example embodiment of a video-capture system 100 according to one or more embodiments of the present disclosure. The video-capture system 100 may involve an automobile 110 that includes a mounted video camera 112 that operates in a driving environment. The video camera 112 may be connected using a wired or wireless network or connection with a data storage device 118 that may be local in the automobile or remotely located. In some embodiments, the video camera 112 may be integrated into a smartphone. Additionally or alternatively, the video camera 112 may be a dedicated device, such as a dashcam. In some embodiments, the network connection between the video camera 112 and the data storage device 118 may be implemented by using a cell network connection associated with the smartphone into which the video camera 112 is integrated. Additionally or alternatively, the network connection may be a dedicated link, such as a wired connection, that facilitates ongoing capture of video data and transmission thereof to the data storage device 118.

During operation, the video camera 112 may capture video data that is stored in the data storage device 118 in, for example, a circular buffer arrangement that is capable of storing a certain amount of video data while discarding older data. In some embodiments, the video camera 112 may or may not capture video data continually while the automobile 110 is operating. The video camera 112 may be triggered to capture the video data by a motion detection sensor, a Light Detection And Ranging (LIDAR) sensor, an infrared sensor, an accelerometer, or any other sensor device corresponding to the automobile 110. In these and other embodiments, the detection of motion or any other trigger condition may initiate operation of the video camera 112 to capture video data associated with activity in the range of the sensor device and the video camera 112. The sensor device may have a rechargeable battery, receive power from the automobile, or be otherwise powered by elements within the operating environment of the automobile 110.

Operation of the video camera 112 may be triggered by a user of the automobile 110 performing a particular action. In some embodiments, the particular action may be implemented via a device included with the automobile 110 and/or the video camera 112 itself, such as an electronic graphical user interface implemented with the automobile 110 and/or the video camera 112. The device may additionally or alternatively be implemented as one or more push buttons or any other type of switch on the video camera 112, a dashboard of the automobile 110, a steering wheel of the automobile 110, a center console of the automobile 110, or in any other way in relation to the automobile 110. Additionally or alternatively, the particular action may be implemented via a device associated with the user of the automobile 110, such as a smartphone owned by the user.

In some embodiments, the particular action that triggers the operation of the video camera 112 may be designed such that the user of the automobile 110 does not divert attention away from operation of the automobile 110 to trigger the operation of the video camera 112. For example, a particular push button implemented with a smartphone application may initiate the operation of the video camera 112 with a single input from the user. As an additional or alternative example, the particular action may involve the user performing a voice-activated command. The voice-activated command may involve one or more predetermined phrases that the user may say to trigger performance of one or more operations of the video camera 112. For example, the voice-activated command may include phrases such as “start recording”, “save recording”, or “upload to social media”.

Although the particular action is described as being used to initiate the operation of the video camera 112, it may be appreciated that the particular action may be used to control one or more different aspects of the operation of the video camera 112. For example, performance of the particular action may initiate more persistent storage of video data already captured by the video camera 112 as described in further detail below. As an additional or alternative example, performance of the particular action may be used to terminate operation of the video camera 112.

Additionally or alternatively, the operation of the video camera 112 may be triggered autonomously without any input from the user of the automobile 110. In some embodiments, the automobile 110 may include an artificial intelligence system 114 and/or an accelerometer 116, which may be used to determine whether and/or at what time an event occurs. In some embodiments, the accelerometer 116 may quantify and record data representative of movement of the automobile 110 as the video data is captured. The accelerometer 116 and/or a computer system configured to process the data collected by the accelerometer 116 may determine an average and/or a baseline velocity, acceleration, or any other metric relating to movement of the automobile 110 based on the data collected by the accelerometer 116. Responsive to recording movement data about the automobile 110 that differs from an average and/or baseline movement metric by a threshold amount, for example, the accelerometer 116 and/or the computer system may indicate that an event has occurred and/or the time at which the change in the movement of the automobile 110 occurred.

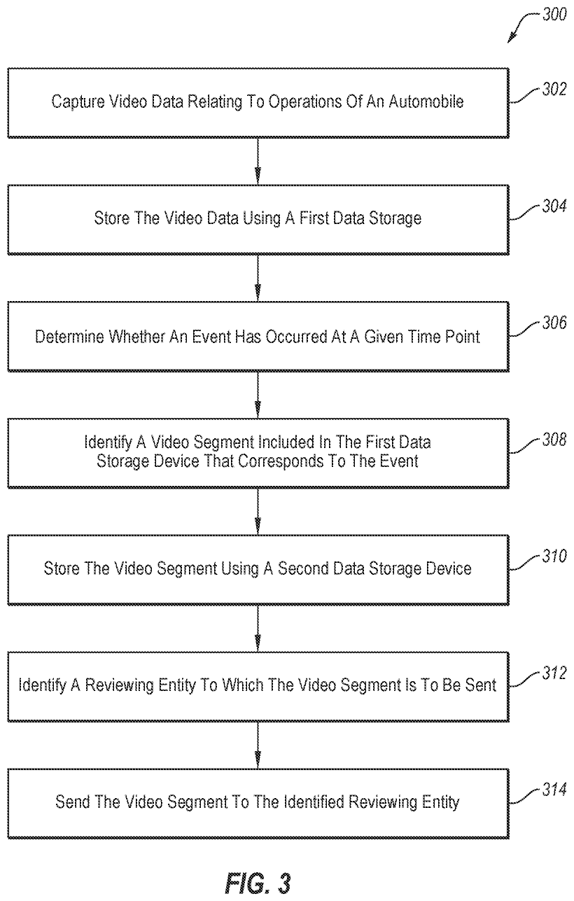

The artificial intelligence system 114 may include code and routines configured to enable a computing system to perform one or more operations. Additionally or alternatively, the artificial intelligence system 114 may be implemented using hardware including a processor, a microprocessor (e.g., to perform or control performance of one or more operations), a field-programmable gate array (FPGA), or an application-specific integrated circuit (ASIC). In some other instances, the artificial intelligence system 114 may be implemented using a combination of hardware and software. In the present disclosure, operations described as being performed by the artificial intelligence system 114 may include operations that the artificial intelligence system 114 may direct one or more corresponding systems to perform. The artificial intelligence system 114 may be configured to perform a series of operations with respect to the automobile 110, the video camera 112, the accelerometer 116, the data storage device 118, the data storage device 120, and/or a reviewing entity 130 as described in further detail below and in relation to an example method 300 as described with respect to FIG. 3.

The artificial intelligence system 114 may be trained to autonomously identify events that occur in the video data captured by the video camera 112. In some embodiments, the artificial intelligence system 114 may be trained using a training dataset that includes video footage depicting one or more events as labeled by a training user. For example, the artificial intelligence system 114 may be trained to identify vehicular collisions using video clips that depict vehicular collisions between different vehicles in a wide variety of environments. As an additional or alternative example, the artificial intelligence system 114 may be trained to identify natural environmental scenery and/or wildlife that may interest the user based on the training dataset including labeled images depicting different types of scenery-of-interest and/or wildlife-of-interest.

The artificial intelligence system 114, which can be implemented locally (e.g., in a smartphone associated with the video camera 112) or remotely, may monitor the video data captured by the video camera 112 to identify the events based on the training. In some embodiments, the artificial intelligence system 114 may include a classification machine-learning model that utilizes a naive Bayes classifier algorithm, a support vector machine algorithm, a logistic regression algorithm, a decision-tree learning approach, some combination thereof, or any other machine-learning algorithm to identify events based on the video data and the training dataset.

In these and other embodiments, a potentially interesting event may be identified by the artificial intelligence system 114, the accelerometer 116, and/or input provided by the user. Upon detection of the event, the computer system may be configured to tag or otherwise designate video data captured by the video camera 112 and stored in the data storage device 118 over a particular duration of time (e.g., in the last 5 seconds, 10 seconds, 30 seconds, 1 minute, 2 minutes, 5 minutes, etc.) for more permanent storage using the data storage device 120. Additionally or alternatively, the computer system may be configured to generate a video segment that includes the tagged or otherwise designated video data captured by the video camera 112 over the particular duration of time and a portion of the video data captured by the video camera 112 over a second duration of time following identification of the event. In other words, the video segment generated by the computer system and stored in the data storage device 120 may include video data preceding and following the identification of the event.

In some embodiments, the data storage device 118 may be configured so that video data stored in the data storage device 118 may be designated to not be discarded by the ongoing buffering and storage of video data responsive to the identification of the event. As described in relation to the data storage device 120, a portion of the video data preceding and/or following the identification of the event may be designated to not be discarded by the data storage device 118.

The data storage device 118 and/or the data storage device 120 may be included in or associated with a cloud service that facilitates longer-term access of the video data. The cloud service may be used to implement a security mode by which the video data is automatically captured and transmitted to the data storage device 118 and/or the data storage device 120, including when the automobile 110 is not in operation. Implementation of the security mode in connection with the video camera 112, the data storage device 118, and/or the data storage device 120 may provide additional features that may improve operation of the video-capture system 100 and/or of the automobile 110 itself. Responsive to the computer system detecting an event with a determination that the event is consistent with a security threat, for example, the video-capture system 100 may automatically notify the user.

In some embodiments, metadata associated with the video data may be stored in the data storage device 118, the data storage device 120, or elsewhere. The metadata associated with the video data may be used to increase the information associated with the video data, which may facilitate more accurate event identification, such as by the artificial intelligence system 114. For example, the metadata may include information relating to a location of the automobile 110, a speed of the automobile 110, a time and/or a date associated with the video data, a temperature or other climate information about an environment to which the video data relates, some combination thereof, or any other relevant information. The metadata may be associated with specific portions of the video data. As such, a particular video segment relating to a particular identified event may include information relating to the specific portions of the video data involved with the particular video segment.

In these and other embodiments, the metadata may facilitate determination of whether a particular portion of the video data is potentially interesting and should be identified as an event. For example, the metadata may provide additional information that the artificial intelligence system 114 may be trained to use in identifying events, such as geolocation data pertaining to the video data. Additionally or alternatively, the metadata may be used in social media posts or other instances in which the video data is shared.

The video data stored in the data storage device 118 and/or the data storage device 120 may be made available for either immediate or later use by the reviewing entity 130. The reviewing entity 130 may include an entity that is interested in particular types of video segments segment stored in the data storage device 118 and/or in the data storage device 120. The reviewing entity 130 may review the video segments, analyze the video segments, share the video segments with others, for example, via text messages or over a social network, or perform any other appropriate operation using the video segments.

Modifications, additions, or omissions may be made to the video-capture system 100 without departing from the scope of the present disclosure. For example, the designations of different elements in the manner described is meant to help explain concepts described herein and is not limiting. For instance, in some embodiments, the automobile 110, the video camera 112, the artificial intelligence system 114, the accelerometer 116, the data storage device 118, the data storage device 120, and the reviewing entity 130 are delineated in the specific manner described to help with explaining concepts described herein but such delineation is not meant to be limiting. Further, the video-capture system 100 may include any number of other elements or may be implemented within other systems or contexts than those described.

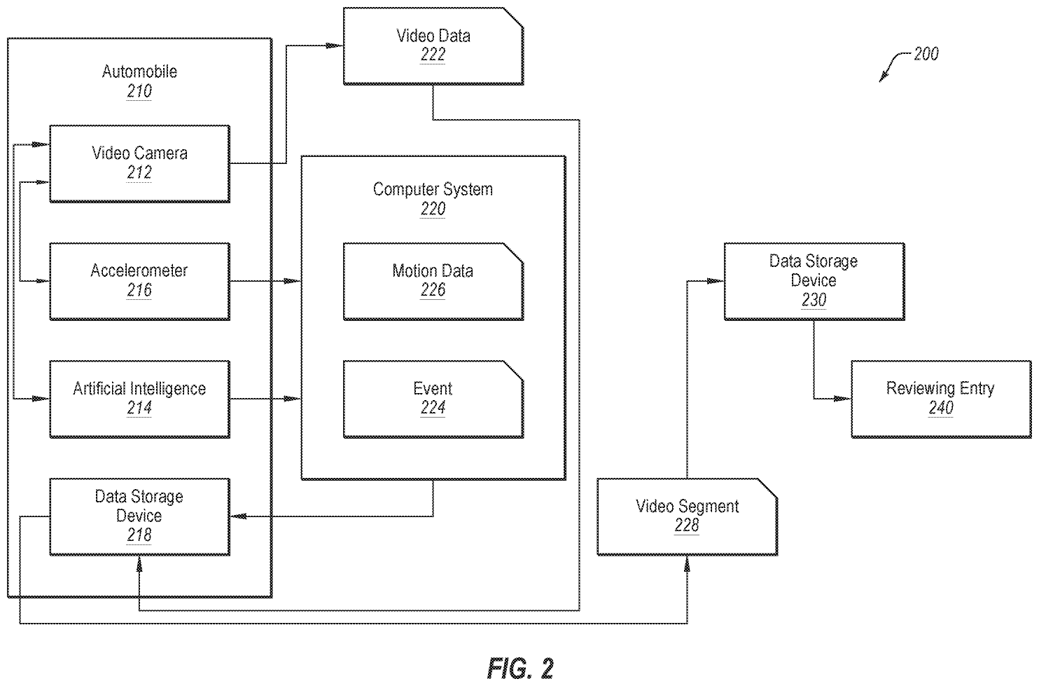

FIG. 2 depicts an example process 200 of generating a video segment 228 and sending the video segment 228 to the reviewing entity 240 using the video-capture system 100 described in one or more embodiments of the present disclosure. The process 200 of FIG. 2 may be performed is between the automobile 210, which may be the same as or similar to the automobile 110 of FIG. 1, and a data storage device 218, which may be the same as or similar to the data storage device 120 of FIG. 1.

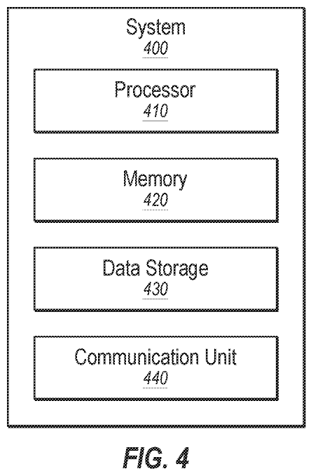

The automobile 210 may perform instructions relating to operations of the video camera 212, the artificial intelligence system 214, the accelerometer 216, and/or the data storage devices 218. The video camera 212, the artificial intelligence system 214, the accelerometer 216, and/or data storage devices 218 in FIG. 2 may include processors (e.g., processors 410 of FIG. 4), memory (e.g., memory 420 of FIG. 4), communication unit (e.g., communication unit 440), a user interface device, combinations thereof or other suitable hardware that are configured to perform operations as described in relation to the aforementioned elements. Additionally or alternatively, the video camera 212, the artificial intelligence system 214, the accelerometer 216, and/or the data storage device 218 may include any software that may be installed and provide instructions that may be performed by the aforementioned elements. For example, the aforementioned elements may include web browsers, information worker software (e.g., data management applications, word processors, email services, enterprise resource planning software, and/or financial software), enterprise infrastructure software (e.g., database management software, business workflow software, geographic information systems, and/or digital asset management software), some combination thereof, or any other application software.

In some embodiments, the video camera 212 may include any device, system, component, or collection of components configured to capture images. The video camera 212 may be configured to capture video data representative of objects within a field of view defined by a lens of the video camera 212. The lens may include optical elements such as, for example, lenses, filters, holograms, splitters, etc. The video camera 212 may also include an image sensor upon which the video data may be capture (e.g., recorded). The image sensor may include any device that converts incident light into an electronic signal. Characteristics of the video data captured by the video camera 212 may be based on a resolution, a magnification, the field of view, a depth of field, or any other aspects defined by the lens of the video camera 212. The camera type for the video camera 212 may include, but is not limited to, a digital camera that may be adapted for use with the components and/or systems of the automobile 210. The image sensor may include pixel elements, which may be arranged in a pixel array (e.g., a grid of pixel elements); for example, the image sensor may include a charge-coupled device (CCD) or complementary metal-oxide-semiconductor (CMOS) image sensor. The pixel array may include a two-dimensional array with an aspect ratio of 1:1, 4:3, 5:4, 3:2, 16:9, 10:7, 6:5, 9:4, 17:6, or any other ratio. The image sensor may be optically aligned with various optical elements that focus light onto the pixel array, for example, a lens. Any number of pixels may be included such as, for example, 8 megapixels, 15 megapixels, 20 megapixels, 50 megapixels, 100 megapixels, 200 megapixels, 600 megapixels, 1000 megapixels, or any other number of pixels.

In some embodiments, the video camera 212 may be capable of capturing the video data at any frame rate, such as 60 frames per second (fps), 120 fps, 240 fps, or any other frame rate. The video camera 212 may be capable of using rolling shutters, global shutters, another type of shutter, or a combination thereof. In some embodiments, the video camera 212 may include color filter array, such as a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Although described as a singular video camera 212 in relation to the process 200, any number of video cameras may be contemplated. In some embodiments, the video camera 212 may continuously capture video data 222 during operation of the automobile 210. In some embodiments, initiating operation of the automobile 210 may trigger the video camera 212 to begin capturing the video data 222, which may or may not include audio corresponding to the video data 222. Additionally or alternatively, a user may manually initiate and/or stop the video camera 212 capturing the video data 222. Additionally or alternatively, the video camera 212 may continuously capture video data 222 before operation of the automobile 210 and/or after operation of the automobile 210. In these and other embodiments, the video camera 212 may be triggered by external stimulus, such as detection of movement in the vicinity of the automobile 210, and/or manually by the user of the automobile 210 (e.g., by turning the video camera 212 on or off when the automobile 210 is not in operation).

The video camera 212 may send the video data 222 to the data storage device 218, which may be the same as or similar to the data storage device 118 described in relation to the video-capture system 100 of FIG. 1. For example, the data storage device 218 may include a circular buffer system with a particular storage capacity; upon storing enough video data to reach the particular storage capacity, the oldest stored video data may be overwritten by current video data.

In some embodiments, initiation and/or termination of capturing the video data by the video camera 212 may be facilitated by one or more other computing systems associated with the artificial intelligence system 214 and/or the accelerometer 216. Information captured by the accelerometer 216 and/or determinations made by the artificial intelligence system 214 may inform the user of the automobile 210 whether potential events in the vicinity of the automobile 210 may be worth recording. Additionally or alternatively, the artificial intelligence system 214 and/or the accelerometer 216 may autonomously initiate and/or terminate operations of the video camera 212 based on gathered information.

In some embodiments, the artificial intelligence system 214 may be configured to identify an event 224. The event 224 may represent an occurrence in the real world in the vicinity of the automobile 210 that may or may not be of interest to the user of the automobile 210. For example, the event 224 may involve an automobile collision between the automobile 210 and another vehicle, a nearby automobile collision, an action of another automobile that may cause an automobile collision, a beautiful scenery, some combination thereof, or any other occurrences in the vicinity of the automobile 210 that may be of interest to the user.

The accelerometer 216 may be configured to record motion data 226 corresponding to the automobile 210. The motion data 226 may include velocity, acceleration, or any other metric relating to movement of the automobile 210.

The accelerometer 216 may also include a LIDAR sensor, a radar sensor, a sound-detecting sensor (e.g., a directional microphone), or any other sensor that is configured to capture data relating to the automobile 210. Additionally or alternatively, although described as the motion data 226, it may be appreciated that sensor data corresponding to any other sensors used in addition or as an alternative to the accelerometer 216 may be captured in addition to or in lieu of the motion data 226.

The video data 222 may be stored in the data storage device 218. In some embodiments, a computer system 220 may be configured to identify portions of the video data 222 that correspond to the event 224 and/or particular portions of the motion data 226. As previously described in relation to the video-capture system 100 of FIG. 1, for example, a timestamp corresponding to when the event 224 was identified and/or when a particular portion of the motion data 226 was captured may be used identify a corresponding video segment 228 included in the video data 222. Additionally or alternatively, identifying the video segment 228 may be facilitated by comparing metadata associated with the video data 222 with metadata associated with the event 224 and/or the motion data 226. Responsive to determining that the metadata associated with a particular portion of the video data 222 is the same as or similar to the meta data associated with the event 224 and/or the motion data 226, a timestamp of the particular portion of the video data 222 may be identified, and a corresponding video segment 228 may be generated.

The computer system 220 may identify video segments 228 from the video data 222. The video segments 228 may be stored in the data storage device 230. In some embodiments, the data storage device 230 may be a more persistent storage device than the data storage device 218. For example, the data storage device 230 may include a larger storage capacity than the data storage device 218. As an additional or alternative example, the data storage device 230 may or may not include a circular buffer process such that older video segments 228 are not overwritten by newer video segments 228. In these and other embodiments, the data storage device 230 and/or the data storage device 218 may be implemented as part of a cloud service. By implementing the data storage device 230 and/or the data storage device 218 as part of a cloud service, sending the video segment 228 to the reviewing entity 240 may be simpler and/or more efficient if the reviewing entity 240 is capable of communicating with the cloud service. In some embodiments, the reviewing entity 240 may include a law enforcement agency or an insurance company. Additionally or alternatively, the reviewing entity 240 may include a social network that is instructed to initiate a social media post using the video segment 228.

In some embodiments, the computer system 220 may be configured to autonomously identify the reviewing entity 240 to which the video segment 228 should be sent. The computer system 220 may determine whether the reviewing entity 240 may be interested in receiving the video segment 228 based on the video data corresponding to the video segment 228. The computer system 220 may include an artificial intelligence system (e.g., the artificial intelligence system 214) that is trained to identify a subject matter of the particular video segment 228 based on occurrences in the video data 222. For example, the computer system 220 may identify actions included in the video data based on image-detection and pattern-recognition approaches, metadata associated with the particular video segment 228, audio corresponding to the video data 222, some combination thereof, or any other details relating to the particular video segment 228. Based on these identified actions, the computer system 220 may predictively determine the subject matter of the video segment 228, and the reviewing entity 240 may be identified to review the video segment 228. For example, the video segment 228 may depict a roadside vehicular accident, which may be of interest if the reviewing entity 240 includes to a law enforcement agency and/or a social network. However, an insurance company that insures the driver of the automobile 210 may or may not be interested in the video segment 228 depicting the roadside vehicular accident. As such, the video segment 228 may be sent to the law enforcement agency and posted on a social media account on the social network, while the insurance company does not receive the particular video segment 228.

Modifications, additions, or omissions may be made to the process 200 without departing from the scope of the present disclosure. For example, the designations of different elements in the manner described is meant to help explain concepts described herein and is not limiting. For instance, in some embodiments, the automobile 210, the video camera 212, artificial intelligence system 214, accelerometer 216, data storage device 218, data storage device 230, and reviewing entity 240 are delineated in the specific manner described to help with explaining concepts described herein but such delineation is not meant to be limiting. Further, the process 200 may involve or be implemented by one or more additional elements or may be implemented within other systems or contexts than those described.

FIG. 3 is a flow chart of an example method 300 of capturing and processing video data according to one or more embodiments of the present disclosure. The method 300 may be performed by any suitable system, apparatus, or device. For example, the automobile 110, the video camera 112, the artificial intelligence system 114, the accelerometer 116, the data storage device 118, the data storage device 120, and the reviewing entity 130 of FIG. 1 may perform one or more operations associated with the method 300. Although illustrated with discrete blocks, the steps and operations associated with one or more of the blocks of the method 300 may be divided into additional blocks, combined into fewer blocks, or eliminated, depending on the particular implementation.

The method 300 may begin at block 302, where video data relating to operations of an automobile are captured. The video data may be captured by a camera associated with the automobile. For example, the camera may include a video camera installed on an exterior of the automobile. As an additional or alternative example, the camera may include a dashcam installed inside of the automobile. As an additional or alternative example, the camera may be included as part of the automobile's user's smartphone, which may be mounted in and connected to the automobile.

At block 304, the video data may be stored using a first data storage device. In some embodiments, the first data storage device may perform a circular buffer process in which older video data stored on the first data storage device is overwritten by newer video data upon the video data exceeding a storage capacity of the first data storage device.

At block 306, whether an event has occurred at a given time point may be determined based on the video data. In some embodiments, determination of whether the event has occurred may involve measuring changes in motion of the automobile using an accelerometer or any other sensors. In these and other embodiments, changes in the motion of the automobile exceeding a threshold value may indicate that the event has occurred. Additionally or alternatively, metadata associated with the video data captured at block 302 may be collected. The metadata associated with the video data may be used in determining whether the event has occurred.

Additionally or alternatively, whether the event has occurred may be determined by an artificial intelligence system, such as the artificial intelligence system 114 and/or the artificial intelligence system 214 of FIGS. 1 and 2, respectively. The artificial intelligence system may be located locally with the camera. For example, the artificial intelligence system may be included as part of an application running on the smartphone on which the camera is located. Additionally or alternatively, the artificial intelligence system may be located remotely from the automobile. For example, the artificial intelligence system may be included as part of a cloud service in which the cloud service is communicatively coupled with the automobile during operation of the automobile.

In some embodiments, the user of the automobile may manually identify occurrence of the event, such as via a user interface. The user interface may include buttons that allow for user input regarding indication of a user-detected event. Additionally or alternatively, the user interface may be configured to notify the user of autonomous detection of the event, such as by the artificial intelligence system. Additionally or alternatively, the user interface may include an element for sending a video segment identified according to block 308 below to a user-specified reviewing entity.

At block 308, a video segment included in the first data storage device that corresponds to the event may be identified. The video segment may represent a portion of the video data stored on the first data storage device as described above in relation to FIGS. 1 and 2.

At block 310, the video segment may be stored using a second data storage device. In some embodiments, the second data storage device may include a second storage capacity that is larger than the first storage capacity of the first data storage device. In some embodiments, the second data storage device may be included as part of a cloud service

At block 312, a reviewing entity to which the video segment is to be sent may be identified. In some embodiments, identification of the reviewing entity may be based on the subject matter and/or content included in the video segment. The reviewing entity may include, for example, a law enforcement agency, an insurance company, a social media platform, or any other entities that may be interested in videos captured in relation to the automobile.

At block 314, the video segment may be sent to the identified reviewing entity. In some embodiments, sending the video segment to the identified reviewing entity may involve initiating a post on a social network. The process of sending the video segment may involve an element of the user interface in which the user interface includes a button or other prompt that allows the user to initiate sending of the video segment with only a single user input.

Modifications, additions, or omissions may be made to the method 300 without departing from the scope of the disclosure. For example, the designations of different elements in the manner described is meant to help explain concepts described herein and is not limiting. Further, the method 300 may include any number of other elements or may be implemented within other systems or contexts than those described.

FIG. 4 illustrates an example computing system 400 configured to capture and process video data according to one or more embodiments of the present disclosure. The computing system 400 may include a processor 410, a memory 420, a data storage 430, and/or a communication unit 440, which all may be communicatively coupled. Any or all of the video-capture system 100 of FIG. 1 may be implemented as a computing system consistent with the computing system 400.

Generally, the processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 410 may include any number of processors distributed across any number of network or physical locations that are configured to perform individually or collectively any number of operations described in the present disclosure. In some embodiments, the processor 410 may interpret and/or execute program instructions and/or process data stored in the memory 420, the data storage 430, or the memory 420 and the data storage 430. In some embodiments, the processor 410 may fetch program instructions from the data storage 430 and load the program instructions into the memory 420.

After the program instructions are loaded into the memory 420, the processor 410 may execute the program instructions, such as instructions to cause the computing system 400 to perform the operations of the method 300 of FIG. 3. For example, the computing system 400 may execute the program instructions to capture video data relating to operations of an automobile, store the video data using a first data storage device, determine whether an event has occurred, identify a video segment included in the first data storage device that corresponds to the event, store the video segment using a second data storage device, identify a reviewing entity to which the video segment is to be sent, and/or send the stored video to the identified reviewing entity.

The memory 420 and the data storage 430 may include computer-readable storage media or one or more computer-readable storage mediums for having computer-executable instructions or data structures stored thereon. Such computer-readable storage media may be any available media that may be accessed by a general-purpose or special-purpose computer, such as the processor 410. For example, the memory 420 and/or the data storage 430 may involve the video camera 112, the artificial intelligence system 114, the accelerometer 116, the data storage device 118, and/or the data storage device 120 of FIG. 1. In some embodiments, the computing system 400 may or may not include either of the memory 420 and the data storage 430.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 410 to perform a particular operation or group of operations.

The communication unit 440 may include any component, device, system, or combination thereof that is configured to transmit or receive information over a network. In some embodiments, the communication unit 440 may communicate with other devices at other locations, the same location, or even other components within the same system. For example, the communication unit 440 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 440 may permit data to be exchanged with a network and/or any other devices or systems described in the present disclosure. For example, the communication unit 440 may allow the system 400 to communicate with other systems, such as computing devices and/or other networks.

One skilled in the art, after reviewing this disclosure, may recognize that modifications, additions, or omissions may be made to the system 400 without departing from the scope of the present disclosure. For example, the system 400 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
capturing, by a camera associated with an automobile, video data representative of an operational environment of the automobile;
storing the video data using a first data storage device that includes a first storage capacity, wherein storing the video data using the first data storage device includes overwriting older video data included in the first data storage device with newer video data upon the video data exceeding the first storage capacity;
determining whether an event has occurred at a given time point included in the video data;
responsive to determining that the event has occurred at the given time point, identifying a video segment included in the first data storage device that corresponds to the event;
storing the video segment corresponding to the event using a second data storage device that includes a second storage capacity larger than the first storage capacity;
identifying a reviewing entity to which the video segment is to be sent, the identifying being based on video content included in the video segment; and
sending, from the second data storage device, the video segment to the identified reviewing entity.

2. The method of claim 1, wherein the second data storage device includes a second storage capacity larger than the first storage capacity and facilitates storage of more video segments than the first data storage device.

3. The method of claim 1, wherein the reviewing entity to which the video segment is sent includes a law enforcement agency or an insurance company.

4. The method of claim 1, wherein sending the video segment includes initiating a post on a social network.

5. The method of claim 4, wherein initiating the post on the social network is performed after receiving a single user input on a user interface.

6. The method of claim 1, wherein determining whether the event has occurred includes determining changes in motion of the automobile using sensor data captured by an accelerometer, wherein the changes in motion of the automobile exceeding a threshold value indicates that the event has occurred.

7. The method of claim 1, further comprising obtaining metadata associated with the video data, wherein the metadata is used in determining whether the event has occurred and identifying the reviewing entity to which the video segment is to be sent.

8. The method of claim 1, wherein determining whether the event has occurred is made by an artificial intelligence system.

9. The method of claim 8, wherein the artificial intelligence system is located locally within the camera.

10. The method of claim 1, wherein the second data storage device is a cloud service.

11. A network, comprising:
a camera adapted for use within an automobile for capturing video data during operation of the automobile;
an artificial intelligence system having access to the video data to identify an event;
a first data storage device configured to receive and temporarily store the video data in an ongoing manner during operation
a second data storage device configured to store a portion of the video data that has been designated as being associated with the event included with the video data stored in the first data storage device; and
a user interface configured to perform functions that include:
notifying a user of detection of the event detected by the artificial intelligence system; and
receiving user input for indicating a user-detected event,
wherein the user interface includes an element for sending a video segment associated with the event detected by the artificial intelligence system or the user-detected event to a reviewing entity.

12. The network of claim 11, wherein the camera is integrated into a smartphone.

13. The network of claim 12, wherein the artificial intelligence system is located locally on the smartphone.

14. The network of claim 11, wherein the artificial intelligence system is located remotely from the automobile.

15. The network of claim 11, wherein the element configured to send the video segment associated with the event is a button included with the user interface that initiates sending of the video segment with only a single user input.

16. The network of claim 11, further comprising a motion detection sensor for detecting motion that enables the camera to begin capturing the video data.

17. The network of claim 11, further comprising an accelerometer that measures changes in motion of the automobile in which the changes in motion that exceed a threshold value indicates that the event has occurred.

18. The network of claim 11, wherein the second data storage device is included in a cloud service that enables the video data to be stored and accessed.

19. The network of claim 11, wherein the first data storage device is in communication with a cloud service that can receive the video segment of the video data to enable the video segment to be stored and accessed.

20. The network of claim 11, wherein the reviewing entity to which the video segment is sent includes a law enforcement agency, an insurance company, or a social media platform.
